(19) United States
(12) Patent Application Publication
(10) Pub. No.: US 2016/0083058 A1
(43) Pub. Date: Mar. 24, 2016

(54) SURVIVAL HELMET DEVICE

(71) Applicant: Immanuel Pauli Maki, Boynton Beach, FL (US)

(72) Inventor: Immanuel Pauli Maki, Boynton Beach, FL (US)

(21) Appl. No.: 14/493,514

(22) Filed: Sep. 23, 2014

(51) Int. Cl. B63C 11/06; B63C 11/18; A62B 18/04; B63C 11/20; A62B 18/10

(52) U.S. Cl. CPC B63C 11/06; B63C 11/205; A62B 18/10; A62B 18/04; B63C 11/186

(57) ABSTRACT

A survival helmet device includes an airtight helmet for use with a survival suit. A snorkel member includes an open channel extending into the inner cavity of the helmet. As a user inhales, air passes through the snorkel channel, a one-way inhale valve, an inhale hose member, and is breathed into the user's mouth through a mouthpiece. As the user exhales, air enters an exhale hose member and passes through a one-way exit valve and into a control member. A control valve on the control member is manually operable for controlling passage of the exhaled airflow through an outlet opening and into the surrounding atmosphere. Operation of the control valve permits the user to selectively adjust the amount of air in the suit in order to increase or decrease the buoyancy of the suit. Air that is exhaled into the suit further serves to warm the user's body.

### BACKGROUND OF THE INVENTION

1. Field of the Invention

The present invention relates to immersion survival suits for use in water and, more particularly, to a helmet device for use in combination with an immersion survival suit.

2. Discussion of the Related Art

Immersion survival suits are used to keep a person thermally insulated when in water and are typically stowed on board ships in easily accessible locations. In the event that a ship is sinking or capsized, each person aboard the ship retrieves a suit and puts it on (over their clothing) before abandoning the ship. Immersion survival suits are generally one-size-fits-all and include built-on boots, gloves and a hood. The insulating and waterproof characteristics of the survival suits typically extend a wearer's average survival time in open water by several hours while awaiting rescue.

Survival suits may include an open neck design, wherein a zipper or other fastener is used to close the opening in order to prevent water from entering the suit. Alternatively, survival suits may include a closed neck design, wherein a form-fitting neck and chin portion serves to seal out water. In the past, suits have been equipped with multiple air pockets that are inflatable by mouth through hoses for assisting the user to stay afloat. More recently developed suits are equipped with compressed carbon dioxide cartridges, which rapidly inflate the suit when activated.

The present invention serves to provide a survival helmet device that is adapted for use with presently available immersion survival suits and which provides an efficient and superior method of thermally insulting the wearer's body while also keeping the wearer afloat in open water.

### SUMMARY OF THE INVENTION

The present invention is directed to a survival helmet device including a dome-shaped, airtight helmet surrounding an internal cavity. Attached to the helmet is a snorkel member that includes an open channel extending the length of the snorkel and into the internal cavity of the helmet. A one-way inhale valve permits airflow from the channel of the snorkel into an inhale hose member within the inner cavity of the helmet. A mouthpiece is in airtight communication with the inhale and an opposing exhale hose member. As the user inhales, air passes through the snorkel channel, the one-way inhale valve, the inhale hose member, and is breathed into the user's mouth through the mouthpiece. As the user exhales, air enters the exhale hose member and passes through a one-way exit valve and into a control member. A control valve is manually operable for selectively controlling passage of the exhaled airflow in the control member through an outlet opening and into the surrounding atmosphere. Operation of the control valve permits the user to selectively adjust the amount of air in the suit and helmet in order to alter the buoyancy (i.e. floatation) of the user in an open body of water. When air is exhaled via the user's nose, air enters the internal cavity of the helmet and the suit, thereby further serving to warm the user's body in order to at least delay the onset of hypothermia when in an open body of water.

Objects and Advantages of the Invention

Considering the foregoing, it is a primary object of the present invention to provide a survival helmet device for facilitating thermal insulation within a coupled immersion survival suit using air exhaled by the user.

It is a further object of the present invention to provide a survival helmet device for facilitating floatation of the user of the coupled immersion survival suit using air exhaled by the user.

It is still a further object of the present invention to provide a survival helmet device for manually controlling the buoyancy level of the immersion survival suit.

It is still a further object of the present invention to provide a survival helmet device for conserving the energy of a user.

These and other objects and advantages of the present invention are more readily apparent with reference to the following detailed description and the accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a front elevational view illustrating the survival helmet device of the present invention;

FIG. 2 is a front elevational view illustrating airflow through the survival helmet device of the present invention when the manual exit valve is in the open position;

FIG. 3 is a front elevational view illustrating airflow through the survival helmet device of the present invention when the manual exit valve is in the closed position;

FIG. 4 illustrates a front elevational view illustrating airflow through the survival helmet device and survival suit when the manual exit valve is in the closed position; and

FIG. 5 illustrates a front elevational view illustrating airflow through the survival helmet device and survival suit when the manual exit valve is in the open position.

Like reference numerals refer to like parts throughout the several views of the drawings.

### DETAILED DESCRIPTION OF THE PREFERRED EMBODIMENTS

Referring to the several views of the drawings, the survival helmet device of the present invention is shown in combination with an immersion survival suit 100 and is generally indicated as 10.

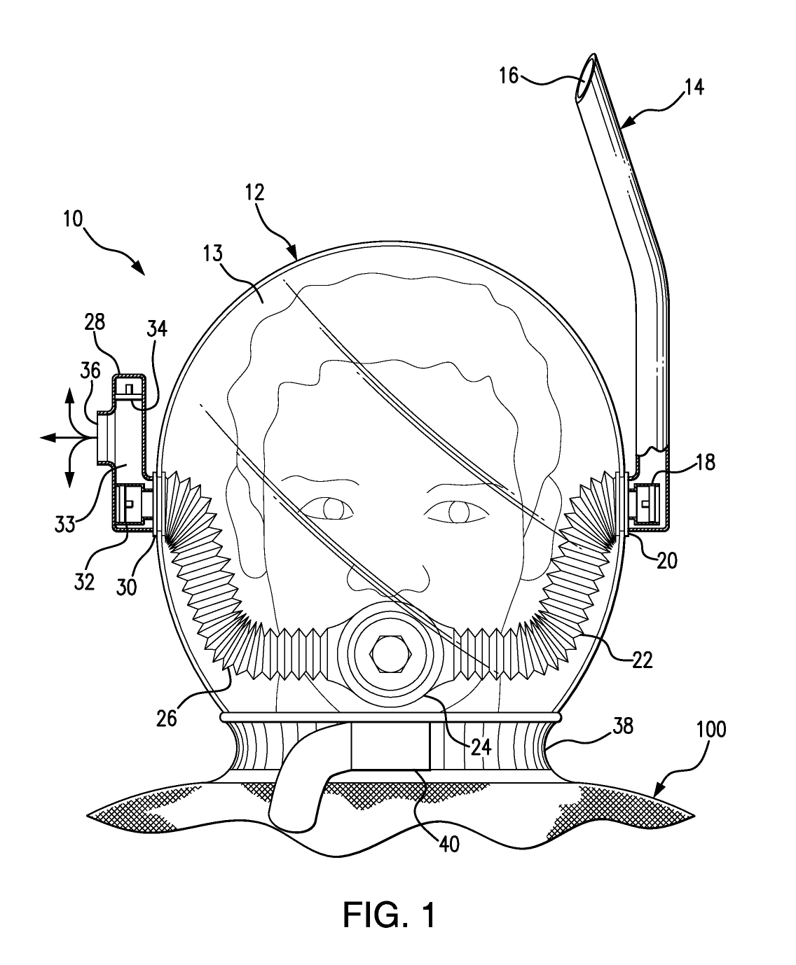

Referring initially to FIG. 1, the survival helmet device 10 includes a dome-shaped, airtight helmet 12 surrounding an internal cavity 13. In one embodiment, as shown throughout the drawings, the helmet is made from resilient, transparent plastic. Attached to the helmet 12 is a snorkel member 14 that includes an inner channel 16 extending the length of the snorkel member 14. A one-way inhale valve 18 permits passage of airflow that enters the channel 16 at the top opening of the snorkel member 14 (via the surrounding atmosphere) through an opening formed in the helmet 12 and into an inhale hose member 22. A seal 20 maintains an airtight, fluid flow connection between the inner channel 16 and the inhale hose member 22 located in the inner cavity of the helmet 12.

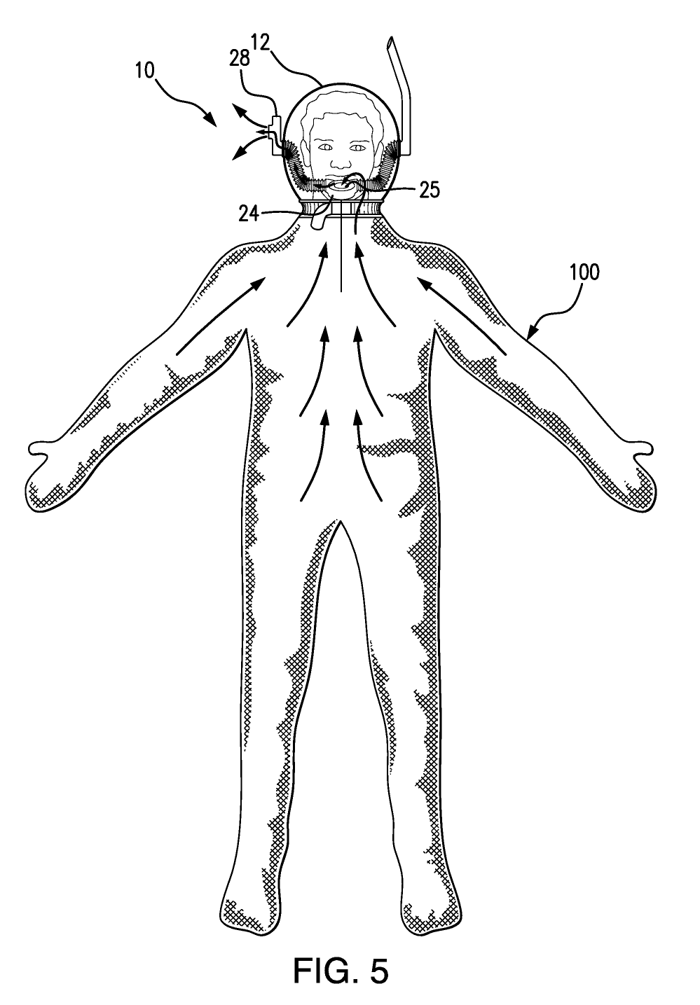

A mouthpiece 24 is connected to the inhale hose member 22 and an exhale hose member 26, forming an airflow channel 27 extending the length of the inhale hose member 22, mouthpiece 24, and exhale hose member 26. A breathing port 25 (see FIG. 5) on the back side of the mouthpiece 24 is sized and configured to form an airtight seal between the user's mouth and the airflow channel 27. The exhale hose member 26 extends from the mouthpiece 24 through an opening on the helmet 12 and is connected to control member 28. A seal 30 maintains an airtight connection between the airflow channel 27 and the inner cavity 33 of control member 28. A one-way exhale valve 32 permits passage of airflow into the inner cavity 33 of the control member 28 from the exhale hose member 26.

Still referring to FIG. 1, a control valve 34 is manually operable for controlling the passage of airflow through the outlet opening 36 on the control member 28 and into the surrounding atmosphere. The user may selectively operate the control valve 34 between an open position for permitting airflow through the outlet opening 36 and a closed position for preventing (i.e., blocking) airflow through the outlet opening 36. A fastening member, such as a strap 38 and fastener 40, is provided for securing an airtight connection between the helmet 12 and the survival suit 100.

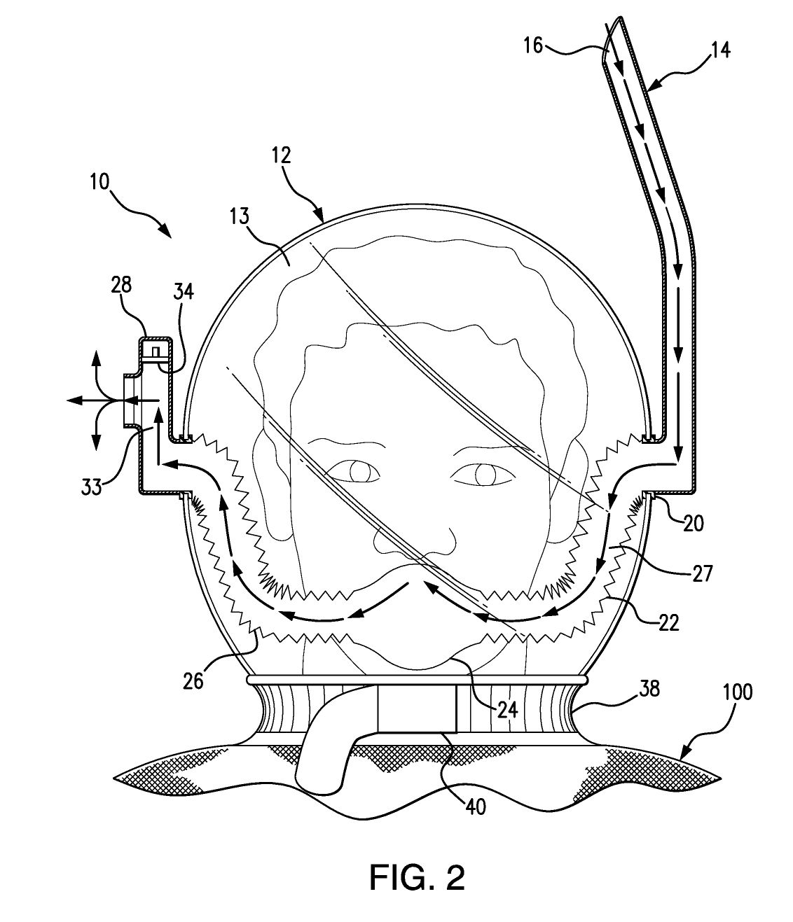

Referring to FIG. 2, the control valve 34 is in the open position for permitting airflow through the outlet opening 36. In operation, as the user inhales through the breathing port on the mouthpiece 24, air enters the snorkel channel 16, passes through the one-way intake valve 18 and into inhale hose member 22, and enters the user's mouth through the mouthpiece 24. As the user exhales into the mouthpiece 24, air enters the exhale hose member 26 and passes through the one-way exhale valve 32 and into the inner cavity 33 of the control member 28. The control valve 34 is manually operable for controlling release of the exhaled airflow out from the inner cavity 33 of the control member 28 and into the surrounding atmosphere.

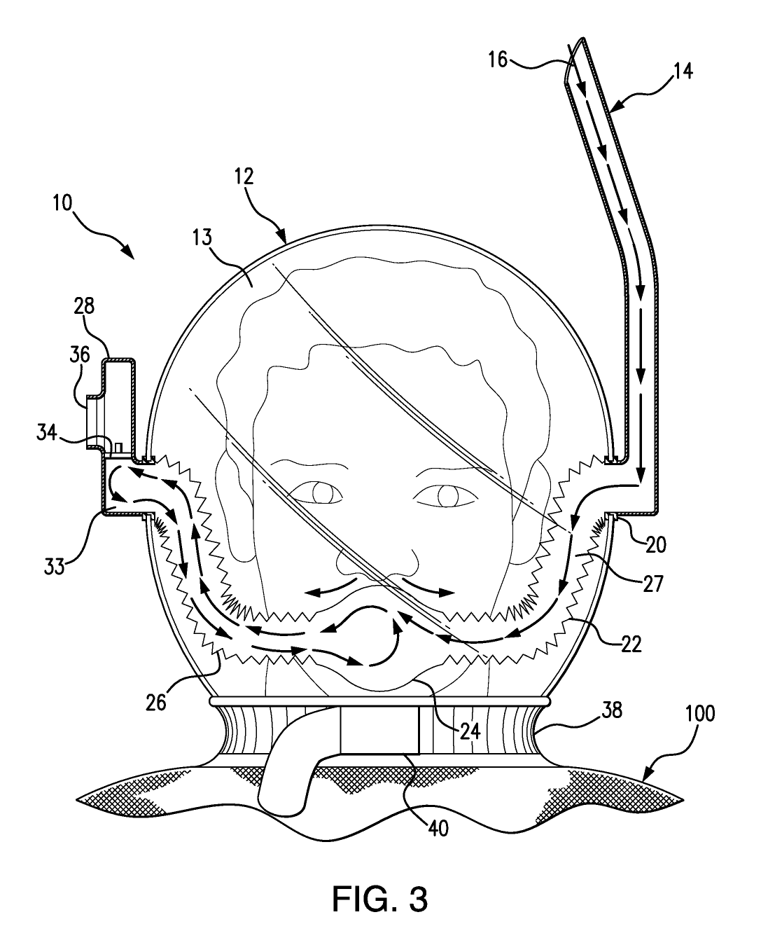

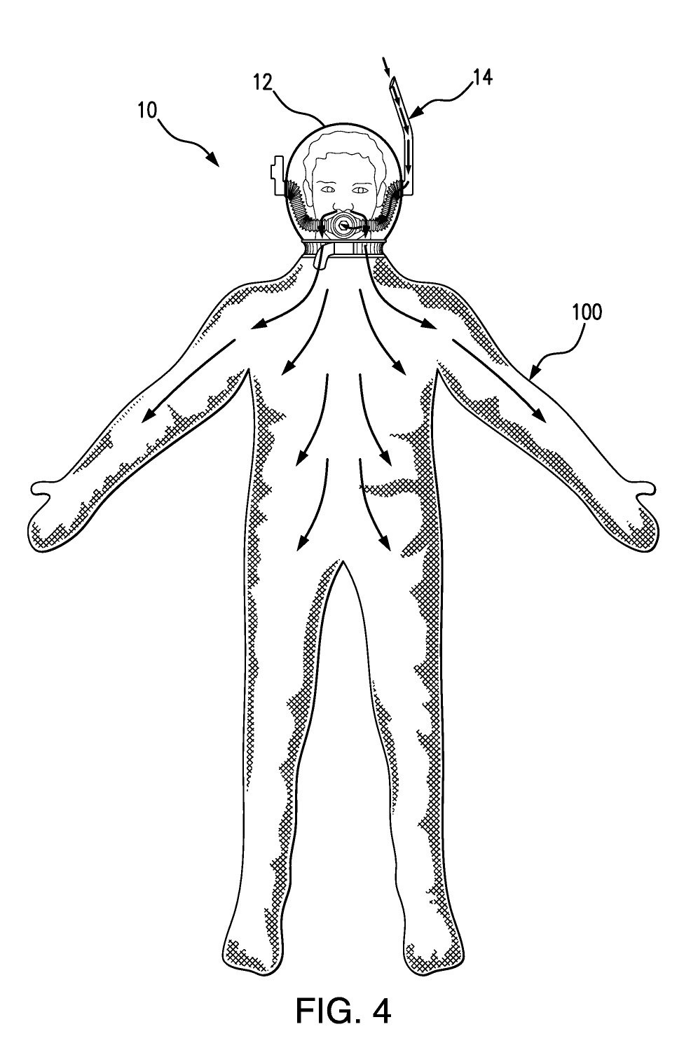

Referring to FIGS. 3 and 4, the control valve 34 is in the closed position for preventing airflow through the outlet opening 36 for the purpose of increasing the pressure within the survival suit 100 with user-exhaled air in order to increase the buoyancy of the user in an open body of water. Moreover, the heat of the exhaled air serves to warm the user's body within the survival suit 100 and helmet 12 for at least delaying the onset of hypothermia. In operation, as the user inhales through the breathing port on the mouthpiece 24, air enters the snorkel channel 16, passes through the one-way intake valve 18 and into inhale hose member 22, and enters the user's mouth through the mouthpiece 24. The user exhales through his or her nose into the internal cavity 13 of the helmet 12 and the exhaled air enters the survival suit 100. The user continues to exhale air through his or her nose until a satisfactory buoyancy level is achieved, at which time the user may resume exhaling through his or her mouth (into the breathing port 25).

Referring to FIG. 5, the user may desire to decrease the pressure within the interior cavity 13 of the helmet 12 and the suit 100 in order to decrease the buoyancy of the suit 100. In operation, the user removes the mouthpiece 24 from his or her mouth, and air from within the survival suit 100 and helmet 12 enters the airflow channel 27 through the breathing port 25. A typical immersion suit 100 holds an amount of oxygen suitable for approximately three minutes of breathing by the user. The air in the airflow channel 27 passes through the one-way exhale valve 32 and into the inner cavity 33 of the control member 28. The control valve 34 is manually operable for controlling release of the exhaled airflow out from control member 28 and into the surrounding atmosphere. When the buoyancy level of the suit 100 is at a satisfactory level, the user re-inserts the breathing port 25 into his or her mouth and opens the control valve to permit exhaled air to exit the device 10 via the outlet opening 36 into the surrounding atmosphere (as shown in FIG. 2). Alternatively, in order to decrease the pressure within the suit 100, the user may inhale air from within the internal cavity 13 of the helmet 12 and suit 100 and exhale into the breathing port 25.

While the present invention has been shown and described in accordance with several preferred and practical embodiments, it is recognized that departures from the instant disclosure are contemplated within the spirit and scope of the present invention which are not to be limited except as defined in the following claims as interpreted under the Doctrine of Equivalents.

What is claimed is:

1. A survival helmet device for use in combination with a survival suit, and said survival helmet device comprising:
a helmet surrounding an internal cavity and having an opening that is sized for passage of a users head therethrough and into the internal cavity, and said helmet being securable to the survival suit;
a snorkel member having an inner channel extending between a top end and a bottom end of said snorkel member, wherein each of said top and bottom ends has an opening in fluid flow communication with the inner channel;
a one-way inhale valve in the inner channel of said snorkel member, and said one-way inhale valve being structured and disposed for permitting passage therethrough of air that is directed into the inner channel from the top end of said snorkel member and towards the bottom end of said snorkel member;
an inhale hose member in the internal cavity of said helmet, and said inhale hose member being secured to the bottom end of said snorkel member through an inhale opening on said helmet;
a mouthpiece in connection with said inhale hose member and an exhale hose member, and said mouthpiece having a breathing port that is sized and configured for selective connection with the user's mouth, wherein fluid flow communication is permitted between an inhale port in connection with said inhale hose member and an exhale port in connection with said exhale hose member;
a control ember surrounding an inner cavity and having an inlet opening and an outlet opening, and wherein said exhale hose member is in connection with the inlet opening on said control member through an exhale opening on said helmet;
an airflow channel formed between the inner channel of said snorkel member, said inhale hose member, said mouthpiece, said exhale hose member, and the inner cavity of said control member;
a one-way exhale valve in the inner cavity of said control member, and said one-way exhale valve being structured and disposed for permitting passage therethrough of air that enters the inner cavity at the inlet opening through the one-way exhale valve and through the outlet opening of said control member; and
a control valve that is manually operable by the user, and said control valve being structured and disposed for selectively permitting or preventing airflow through the outlet opening on said control member, wherein the user may selectively prevent airflow through the outlet opening in order to inflate the survival suit with air exhaled through the user's nose to facilitate heating and floatation of the user in a body of water, and wherein the user may selectively permit airflow through the outlet opening to deflate the survival suit as air enters the airflow channel through the breathing port on said mouthpiece and passes through the one-way exhale valve and the outlet opening on said control member.

2. The survival helmet device as recited in claim 1 wherein said helmet is at least partially transparent.

3. The survival helmet device as recited in claim 1 wherein said helmet is made from plastic.

4. The survival helmet device as recited in claim 1 further comprising a fastening member that is structured and disposed for securing an airtight connection between the helmet and the survival suit.

5. The survival helmet device as recited in claim 1 further comprising a seal that is sized and configured for maintaining an airtight, fluid flow connection between the inner channel of said snorkel member and the airflow channel of said inhale hose member.

6. The survival helmet device as recited in claim 1 further comprising a seal that is sized and configured for maintaining an airtight, fluid flow connection between the airflow channel of said exhale hose member and the inner cavity of said control member.
